(19) United States
(12) Patent Application Publication
(10) Pub. No.: US 2007/0187919 A1
(43) Pub. Date: Aug. 16, 2007

(54) Height adjustment blocks for leaf spring suspension

(75) Inventor: Christopher K. Furman, Augusta, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/352,624

(22) Filed: Feb. 13, 2006

(51) Int. Cl. B60G 11/00; B60G 17/00

(52) U.S. Cl. 280/124.175; 280/6.157; 280/124.17

(57) ABSTRACT

A height adjustable suspension system for a golf car includes a leaf spring and an axle housing rotatably supporting first and second driven wheels. The axle housing is supported by the leaf spring. A support element is connected to the axle housing. A height adjustment block is connected to the support element. The height adjustment block includes a hook-shaped engagement member at least partially engaging the height adjustment block to the support element. The height adjustment block is positioned between the leaf spring and the support element, and together with the support element defines a spacing between the leaf spring and the axle housing.

### FIELD

The present disclosure relates to a device and method for connecting and adjusting suspension elements for golf car and off-road utility vehicles.

### BACKGROUND

The statements in this section merely provide background information related to the present disclosure and may not constitute prior art.

Golf cars and many off-road or utility vehicles, hereinafter “golf cars” commonly have rigid or single axle suspension systems for both the front steerable wheels and the rear driving wheels. Rear suspensions for these vehicles commonly include leaf springs and/or shock absorber assemblies used to support the solid axle. Some golf car designs have therefore utilized leaf spring and shock absorber combinations to both stabilize the vehicle and to provide a more comfortable ride. The leaf springs are also relied on to promote side-to-side and bounce stability of the suspension. Shock absorbers dampen the leaf spring travel and frequency which therefore promote a more stable and comfortable ride feel.

Connection of the various leaf spring and shock absorber components to the frame generally only permits the suspension system to provide for a single vehicle platform. It is often desirable, however, to accommodate multiple vehicle tire sizes or multiple vehicle combinations, such as food/beverage service carts, or sporting versions of the carts. Providing for multiple platform designs increases the costs of manufacture of the suspension system due to different assembly requirements, as well as the requirement to develop and stock multiple parts for both construction and for repair/replacement.

### SUMMARY

According to several embodiments of the present disclosure, a suspension system height adjustment device for a golf car includes a substantially planar main segment. Opposed first and second side walls are homogenously joined to a connecting wall. The first and second side walls and the connecting wall substantially define a U-shape. The first and second side walls are oriented substantially transverse to the main segment, having at least one of the first and second side walls connected to the main segment. Opposed first and second end walls are each transversely positioned with respect to the first and second side walls and are homogenously connected to the main segment. A hook-shaped engagement member extends from the first end wall toward the second end wall.

According to other embodiments, a height adjustable suspension system for a golf car includes an axle housing and a support element fixedly connected to the axle housing. A height adjustment block is connected to the support element. The height adjustment block includes a substantially planar main segment. Opposed first and second end walls are each transversely positioned with respect to and homogenously connected to the main segment. A hook-shaped engagement member extends from the first end wall toward the second end wall. The hook-shaped engagement member is operable to engage the support element.

According to yet other embodiments, a height adjustable suspension system for a golf car includes a leaf spring and an axle housing rotatably supporting first and second driven wheels. The axle housing is supported by the leaf spring. A support element is connected to the axle housing. A height adjustment block is connected to the support element. The height adjustment block includes a hook-shaped engagement member at least partially engaging the height adjustment block to the support element. The height adjustment block is positioned between the leaf spring and the support element and operable with the support element to define a spacing between the leaf spring and the axle housing.

According to still other embodiments, a golf car includes a frame member and a leaf spring supported from the frame member. An axle housing is rotatably supported between the leaf spring and the frame member. A support element fixedly connected to the axle housing. A height adjustment block is connected to the support element. The height adjustment block includes a hook-shaped engagement member at least partially engaging the height adjustment block to the support element. The height adjustment block is positioned between the leaf spring and the support element and is operable with the support element to define a spacing between the leaf spring and the axle housing.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a golf car having height adjustment blocks for a leaf spring suspension according to various embodiments of the present disclosure;

FIG. 2 is a bottom plan view of the golf car of FIG. 1;

FIG. 3 is a perspective view of an assembly including a vehicle frame, rear suspension system and height adjustment blocks of the present disclosure;

FIG. 4 is a bottom plan view of the assembly of FIG. 3;

FIG. 5 is perspective view of a height adjustment block of the present disclosure;

FIG. 6 is a side elevational view of the height adjustment block of FIG. 5;

FIG. 7 is a partial cross sectional top elevational view of the height adjustment block of FIG. 5;

FIG. 8 is a bottom plan view of the height adjustment block of FIG. 6;

FIG. 9 is a partial perspective view at area 9 of the assembly of FIG. 3 prior to installation of the height adjustment block;

FIG. 10 is the partial perspective view of FIG. 9 further modified to identify the installed position of the height adjustment block;

FIG. 11 is a rear perspective view of the installed position of the height adjustment block of FIG. 10; and

FIG. 12 is perspective view of a bracket of the present disclosure.

### DETAILED DESCRIPTION

The following description is merely exemplary in nature and is in no way intended to limit the present disclosure, application, or uses. Throughout this specification, like reference numerals will be used to refer to like elements. As referred to herein, the term “golf car” is synonymously used to describe application of the present disclosure to golf cars as well as sport utility vehicles such as modified golf cars, used for example as food and/or beverage cars, golf cars adapted for use as hunting/sporting clays vehicles, golf course maintenance vehicles, and the like.

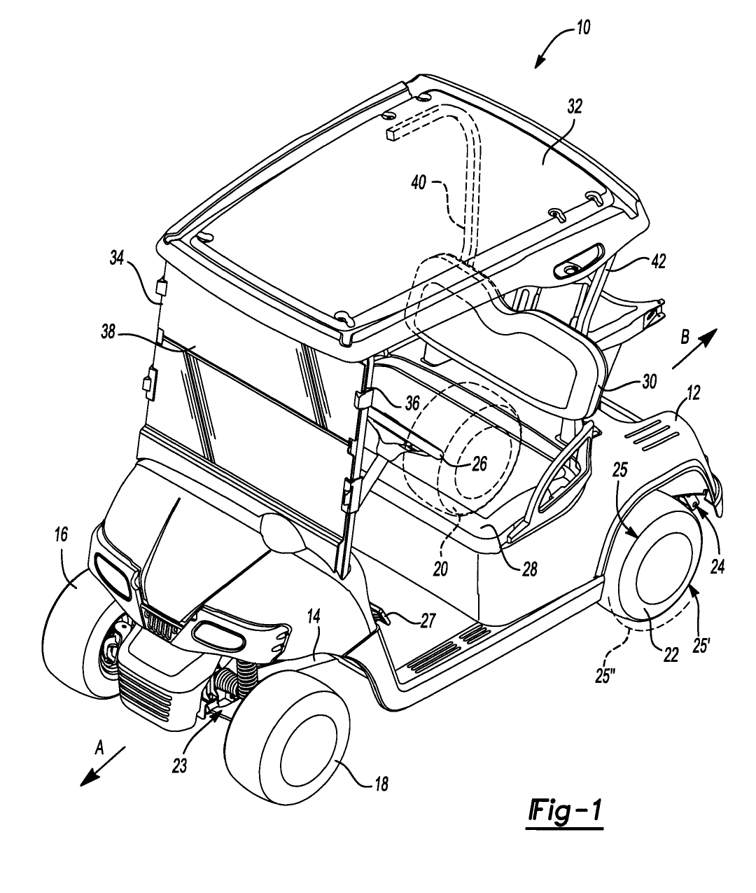

Referring generally to FIG. 1, a golf car 10 can include a body 12 supported from a structural frame 14. Frame 14 can also support a plurality of wheels including a first steerable wheel 16 and a second steerable wheel 18. In addition, powered or driven wheels including a first driven wheel 20 and a second driven wheel 22 are commonly connected to a rear structural portion of frame 14. A front suspension system 23 can also be provided which is adapted for supporting each of the first and second steerable wheels 16, 18. A rear suspension system 24 can also be provided which is adapted for supporting each of the first and second driven wheels 20, 22. At least first and second driven wheels 20, 22 have a diameter 25, which is distinguishable as a first diameter 25′ and a second diameter 25″ (partially shown in phantom), the second diameter 25″ greater than the first diameter 25′. A steering mechanism 26 which commonly includes a steering wheel and a support post assembly is also included to provide the necessary steering input to first and second steerable wheels 16, 18.

Golf car 10 can also include a passenger bench seat 28 and a passenger back support cushion 30. A cover or roof 32 can also be provided which is supported from either body 12 or frame 14 by first and second support members 34, 36. A windscreen or windshield 38 can also be provided which is also supported by each of first and second support members 34, 36. A rear section of roof 32 can be supported by each of a first and a second rear support element 40, 42. Other items provided with golf car 10 include golf bag support equipment, accessory racks or bins, headlights, side rails, fenders, and the like.

Golf car 10 is commonly propelled by a power unit such as an engine or battery/motor system which can be positioned below and/or behind bench seat 28. Golf car 10 is capable of motion in either of a forward direction “A” or a rearward direction “B”. Each of first and second driven wheels 20, 22 can be commonly supported to frame 14 using rear suspension system 24. Each of first and second steerable wheels 16, 18 can be independently or commonly supported to frame 14, therefore the present disclosure is not limited by the design of front suspension system 23.

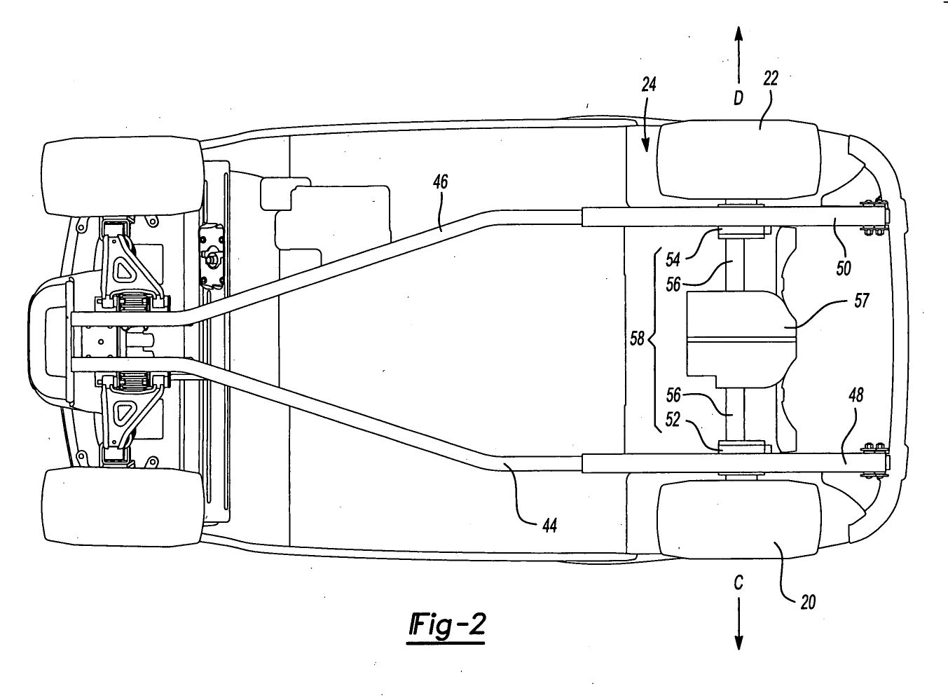

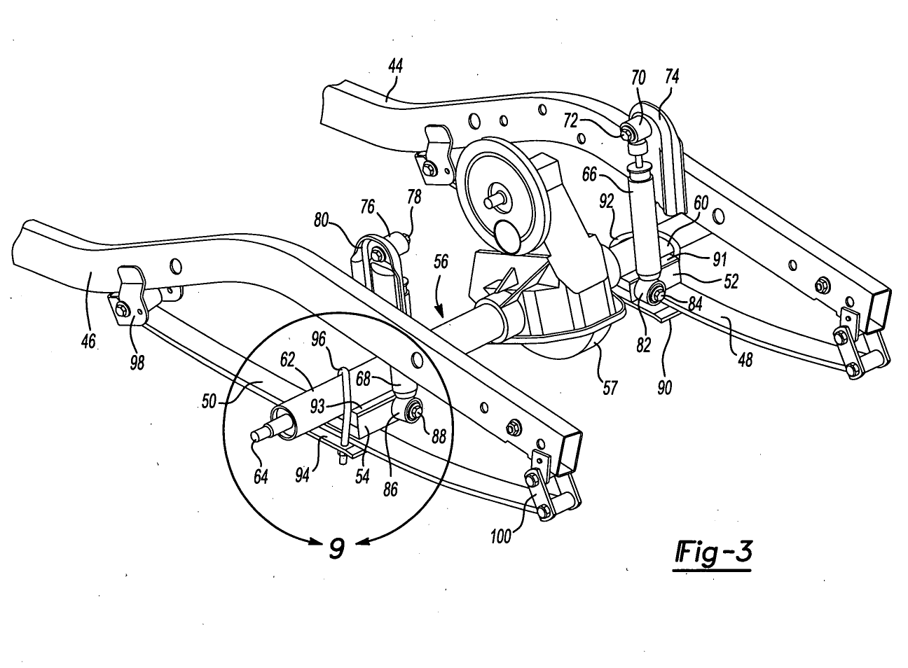

As best seen in reference to FIG. 2, frame 14 can further include a substantially longitudinally arranged first frame member 44 and a second frame member 46. First and second frame members 44, 46 can be hollow, tubular shaped members created of a metal such as a steel material or similar structural material and formed by welding, extruding, hydroforming, or similar processes. A first and second leaf spring 48, 50 are connected at their distal ends to first or second frame members 44, 46 of frame 14 and are supported between their distal ends by first and second height adjustment blocks 52, 54, of the present disclosure. First and second leaf springs 48, 50 also help restrain side-to-side suspension deflection such as in either first or second deflection directions “C” or “D”. First height adjustment block 52 provides installation height adjustment for rear suspension system 24 by connecting first leaf spring 48 to an axle housing 56. Similarly, second height adjustment block 54 provides installation height adjustment for rear suspension system 24 by connecting second leaf spring 50 to axle housing 56. Axle housing 56 has an axle (shown in FIG. 3) rotatably disposed therein for providing driving power to the first and second driven wheels 20, 22 through a gear train or axle gear housing 57 connected to the power unit. Axle housing 56 and axle gear housing 57 in part create a rear drive assembly 58.

Referring now to FIG. 3, multiple components of the rear drive assembly 58 include axle gear housing 57 which divides axle housing 56 into each of a first housing portion 60 and a second housing portion 62. An axle 64 extending beyond distal ends of axle housing 56 is rotatably disposed within axle housing 56. Rotation of axle 64 by axle gear housing 57 provides the rotating drive for first and second driven wheels 20, 22.

According to several embodiments, rear suspension system 24 can further include a first shock absorber 66 and a second shock absorber 68. First shock absorber 66 can include a first connecting sleeve 70 which is fastened using a fastener 72 to a first frame extension 74. First frame extension 74 is a structural element which can be fixedly connected to first frame member 44 for example by welding. Similarly, second shock absorber 68 can include a first connecting sleeve 76 which is connected using a fastener 78 to a second frame extension 80 similar in design to first frame extension 74 but fixedly connected to second frame member 46. First shock absorber 66 can further include a second connecting sleeve 82 which is connected using a fastener 84 to first height adjustment block 52. Similarly, second shock absorber 68 can include a second connecting sleeve 86 connected by a fastener 88 to second height adjustment block 54.

First height adjustment block 52 can be positioned between a first bracket 91 fixed for example by welding to first housing portion 60 and a first support plate 90. First leaf spring 48 is sandwiched between first support plate 90 and first height adjustment block 52 using a first U-shaped bolt 92. Similarly, second height adjustment block 54 can be positioned between a second bracket 93 fixed for example by welding to second housing portion 62 and a second support plate 94 located on a driver's side of golf car 10. Second leaf spring 50 is sandwiched between second height adjustment block 54 and second support plate 94 using a second U-shaped bolt 96.

A forward end of each of the first and second leaf springs 48, 50 can be connected to respective ones of first and second frame members 44, 46 using a bracket 98. A fastener is inserted through opposed walls of bracket 98 and a looped forward end of the first or second leaf spring 48, 50. Bracket 98 can be welded to fixedly connect to the first or second frame member 44, 46. A linkage assembly 100 can connect a rearward end of each of the first and second leaf springs 48, 50 to the corresponding first or second frame member 44, 46. First and second leaf springs 48, 50 help limit the vertical deflection of axle housing 56. First and second shock absorbers 66, 68 dampen the vertical travel of axle housing 56. First and second height adjustment blocks 52, 54 function in part to vertically displace axle housing 56 relative to first and second frame members 44, 46. By maintaining the same relative lengths of first and second shock absorbers 66, 68 when using first and second height adjustment blocks 52, 54, the vertical position of axle housing 56 can be raised (brought closer) with respect to first and second frame members 44, 46 without affecting the relative position of either first or second leaf springs 48, 50 and first and second shock absorbers 66, 68. In order to accomplish this, first and second U-shaped bolts 92, 96 are replaced with longer length bolts when first and second height adjustment blocks 52, 54 are installed. This vertical upward displacement of axle housing 56 and therefore axle 64 provides for use of the increased diameter of second wheel diameter 25″, while retaining most of the same components and configuration of rear suspension system 24 before first and second height adjustment blocks 52, 54 are installed.

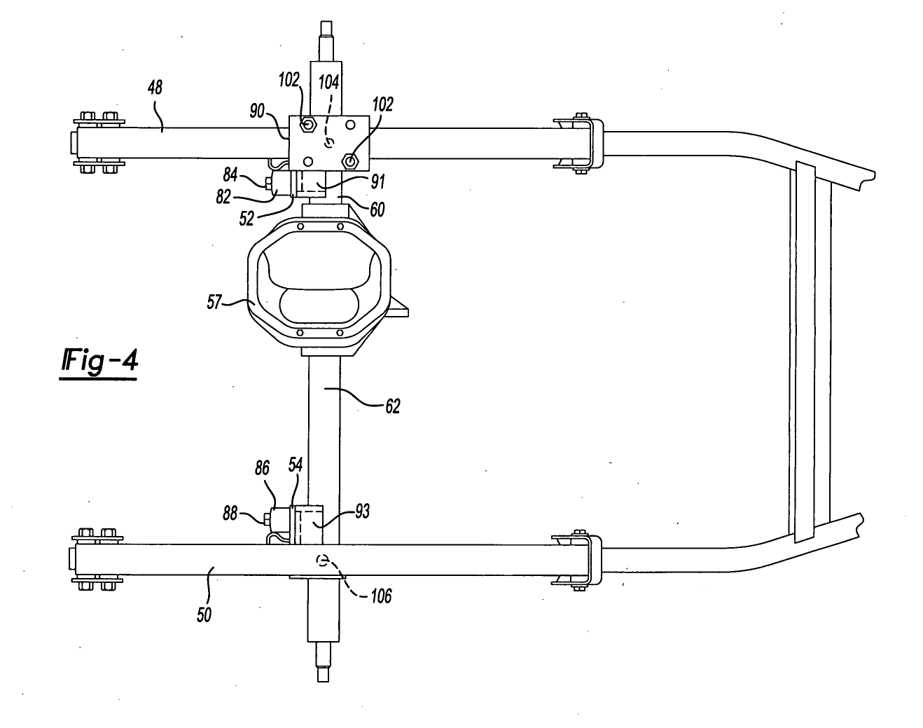

Referring now generally to FIG. 4, it will be evident that axle gear housing 57 can be positioned closer to or further from either of the first or second leaf springs 48, 50. This affects the individual lengths of first or second housing portions 60, 62. First and second U-shaped bolts 92, 96 are fastened to first and second support plates 90, 94 using a plurality of nuts 102. In several embodiments, a pin 104 connected to first leaf spring 48 and a pin 106 connected to second leaf spring 50 (both extending away from the viewer as viewed in FIG. 4) are each received in a corresponding pin receiving aperture 107 (described in reference to FIG. 7) of first and second height adjustment blocks 52, 54. Second support plate 94 is not shown in this view in order to identify the overlapping relationship of second height adjustment block 54 and second bracket 93. Installation of pins 104 and 106 in pin receiving apertures 107 fixes the orientation of rear suspension system 24 relative to frame 14. When first and second height adjustment blocks 52, 54 are used, access is available to each of fastener 84 and fastener 88 to connect first and second shock absorbers 66, 68.

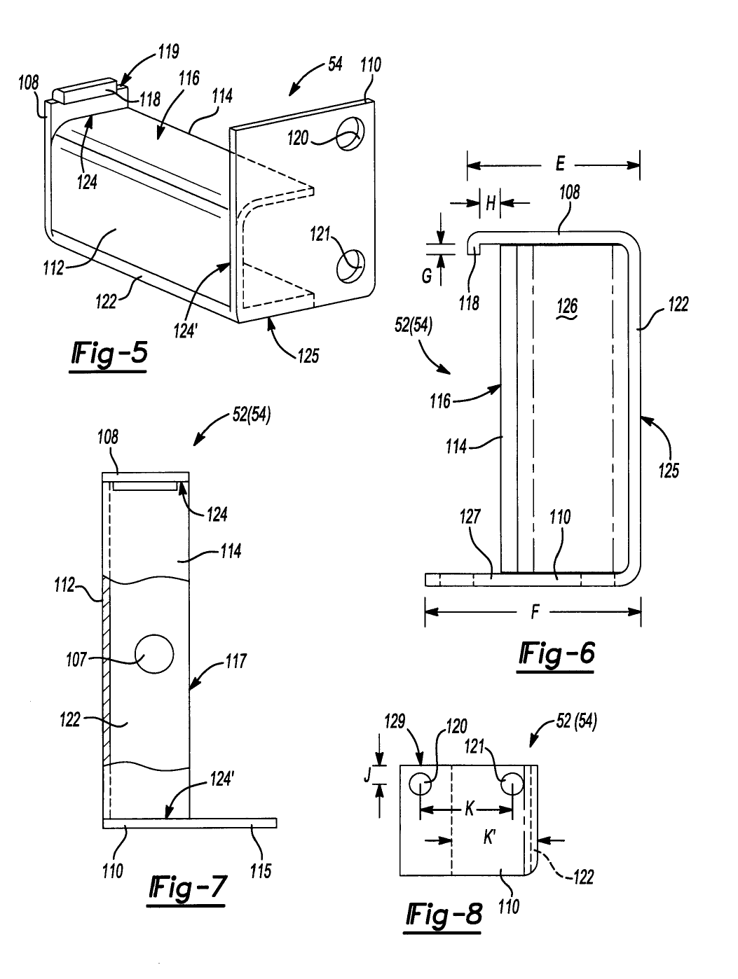

Referring now to FIG. 5, second height adjustment block 54 is shown in greater detail. First height adjustment block 52 is substantially identical to second height adjustment block 54 but is configured in a mirror image arrangement. The following details of second height adjustment block 54 therefore correspond to details of first height adjustment block 52 and first height adjustment block 52 will therefore not be further discussed. Second height adjustment block 54 includes a first end wall 108 and an opposed second end wall 110 which is substantially two times as wide as first end wall 108. A side wall 112 is created substantially transverse to first and second end walls 108, 110. A connecting wall 114 is positioned substantially transverse to side wall 112 and homogenously extends by bending side wall 112 such that connecting wall 114 and side wall 112 together define an L-shape. Connecting wall 114 is substantially planar and further defines a first support surface 116 for engagement with bracket 93. A hook or engagement member 118 extends from a distal end 119 of first end wall 108. Second end wall 110 further includes each of a first and second fastener receiving aperture 120, 121.

In several embodiments, each of the first and second end walls 108, 110, and side wall 112 homogenously extend from a main segment 122 and are each formed by creating a bend proximate to their engagement location with main segment 122. Main segment 122 is substantially planar and is oriented substantially transverse to first and second end walls 108, 110 and to side wall 112. In several embodiments, connecting wall 114 is oriented substantially parallel to main segment 122.

In several embodiments, side wall 112 is positioned by bending proximate to main segment 122, and connecting wall 114 is created by further bending side wall 112 to create the substantially L-shape. To stiffen second height adjustment block 54, end edges of side wall 112 and connecting wall 114 where they abut first and second end walls 108, 110 are fixed for example by weld joints 124, 124′ along their lengths to each of first and second end walls 108, 110. In several embodiments, each of first and second end walls 108, 110 are created by bending at their junction with main segment 122. When first height adjustment block 52 is completed in the configuration shown, an outward facing second support surface 125 is defined by main segment 122. First and second fastener receiving apertures 120, 121 can be created in second end wall 110 either before or after bending second end wall 110 to the position shown by multiple methods including drilling or punching.

Referring now to FIG. 6, when first and second height adjustment blocks 52, 54 are completed, a cavity 126 is defined between side wall 112, connecting wall 115 and main segment 122. First end wall 108 has a first length “E” and second end wall 110 has a second length “F”. Second length “F” is measured with respect to second support surface 125. In several embodiments, second length “F” is greater than first length “E”, creating a free extending portion 127 extending beyond first support surface 116, whose functions will be discussed later herein. Engagement member 118 extends away from first end wall 108 and toward second end wall 110 by a stand-off dimension “G”. Engagement member 118 also extends away from first support surface 116 by an engagement depth “H”. Engagement member 118 therefore substantially forms a hook-shaped member.

Referring now to FIG. 7, pin receiving aperture 107 is created in main segment 122 to receive pin 106 extending from second leaf spring 50. Pin receiving aperture 107 therefore has a diameter larger than a diameter of pin 106 to permit a sliding engagement with pin 106. In a similar but opposite handed configuration for first height adjustment block 52 (not shown), a similar pin receiving aperture 107 is also created in first height adjustment block 52 to receive pin 104 of first leaf spring 48. A portion 115 of second end wall 110 extends beyond a free end 117 of connecting wall 114 to provide for overlap of second bracket 93. First and second fastener receiving apertures 120, 121 are both located within portion 115.

Referring now to FIG. 8, each of first and second fastener receiving apertures 120, 121 are co-axially aligned with respect to an edge 129 of second end wall 110. Both first and second fastener receiving apertures 120, 121 are spaced from edge 129 by an aperture spacing dimension “J” and are spaced with respect to each other by a dimension “K”. A spacing K′ from second support surface 125 to first support surface 116 is the same as dimension “K” to maintain a common mounting position for shock absorbers 66, 68. Second fastener receiving aperture 121 is positioned with respect to main segment 122 to permit a nut (not shown) to be positioned on an inward facing side (facing away from the viewer) of second end wall 110 without interfering with main segment 122 when the nut is co-axially aligned with second fastener receiving aperture 121. The nut threadably receives one of fastener 84 or fastener 88.

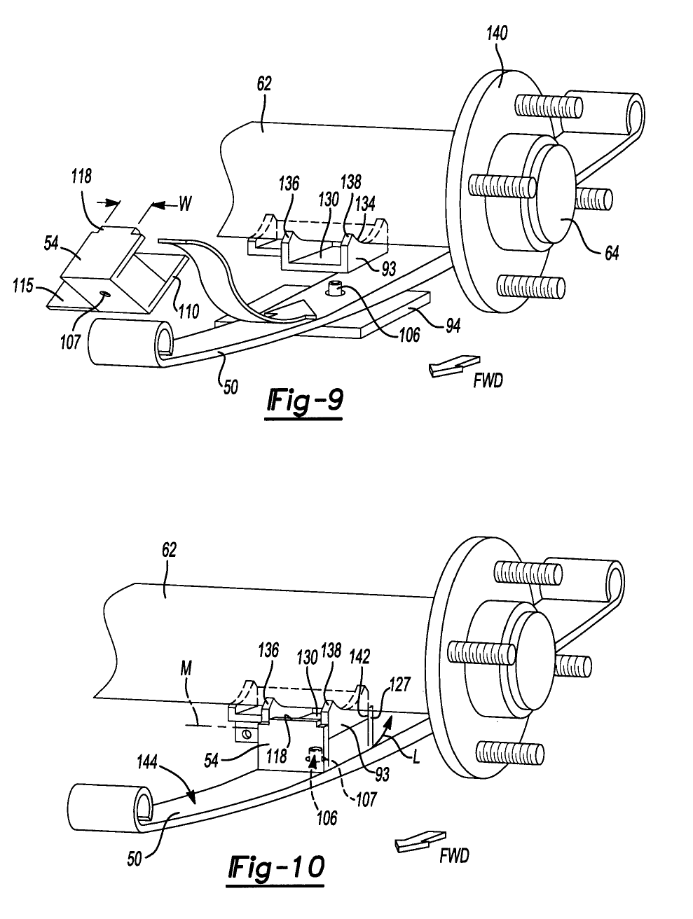

Referring now generally to FIG. 9, the installation sequence for second height adjustment block 54 first requires the second housing portion 62 of axle housing 56 to be vertically displaced with respect to second leaf spring 50. Installation of first height adjustment block 52 is substantially identical and will therefore not be further discussed herein. Second height adjustment block 54 is initially positioned as shown such that engagement member 118 can be engaged with an engagement section 130 of second bracket 93 which is already in position. Second bracket 93 is fixedly connected to second housing portion 62 using for example a plurality of weld joints 134. The previously described stand-off dimension “G” and engagement depth “H” of engagement member 118 are predetermined to substantially match a material thickness of engagement section 130 and a desired engagement depth of engagement member 118. A width “W” of engagement member 118 is predetermined to be slidably received between each of a first and second element side wall 136, 138 of second bracket 93. Second support plate 94 and pin 106 are shown for reference with respect to second leaf spring 50. Pin 106 will be received in pin receiving aperture 107 of second height adjustment block 54 when installation of second height adjustment block 54 is complete. As further shown, a wheel hub 140 is rotatably connected at both distal ends of axle 64 to rotatably support each of first and second driven wheels 20, 22. Positioning of both second leaf spring 50 and second bracket 93 are therefore in part pre-determined by the spacing required to wheel hub 140 to permit free rotation of either the first or second driven wheels 20, 22.

As best seen in reference to FIG. 10, when engagement member 118 hooks over or engages with engagement section 130, second height adjustment block 54 can then be rotated about an arc of rotation “L” and an axis of rotation “M” defined at engagement member 118. Second height adjustment block 54 is rotated until second end wall 110 including portion 115 contact an end face 142 of second bracket 93 and first support surface 116 contacts a downward facing surface of second bracket 93. In this position, second support surface 125 of second height adjustment block 54 contacts an upper face 144 of second leaf spring 50. Also in this position, pin 104 is received within pin receiving aperture 107 to fix the relative positions of second housing portion 62, second height adjustment block 54, and second leaf spring 50.

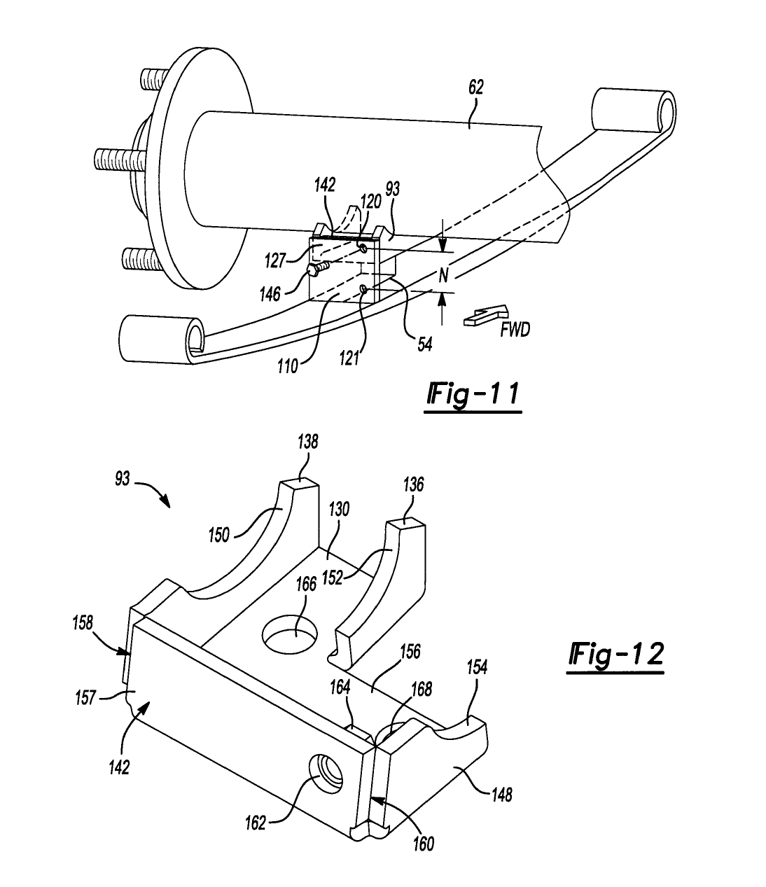

Referring now to FIG. 11, when rotation of second height adjustment block 54 is complete, first support surface 116 is in contact with the downward facing surface of second bracket 93 and free extending portion 127 of second end wall 110 overlaps and abuts against end face 142. In this position, first fastener receiving aperture 120 is co-axially aligned with a corresponding aperture (not visible in this view) previously created in end face 142 originally receiving fastener 88 of second shock absorber 68. Fastener 88 is removed prior to installation of second height adjustment block 54 and is subsequently replaced with a fastener 146 to fastenably engage free extending portion 127 to end face 142, and therefore fixedly connect second height adjustment block 54 to second bracket 93 having engagement member 118 providing the opposite engagement feature. The desired amount of vertical displacement provided by second housing portion 62 is defined by a predetermined lift dimension “N” used to space second fastener receiving aperture 121 from first receiving aperture 120. In some embodiments, lift dimension “N” can range between approximately 1.5 in (3.81 cm) to 2.5 in (6.35 cm). It will be evident that the present disclosure is not limited by the dimension selected for lift dimension “N”, and either larger or smaller dimensions from those identified herein can be used. After installation of fastener 146, fastener 88 is repositioned within second connecting sleeve 86 of second shock absorber 68 and inserted through second fastener receiving aperture 121. A nut (not shown) positioned on an opposing side of second end wall 110 can be pre-positioned and co-axially aligned with second fastener receiving aperture 121 to threadably receive fastener 88, or second fastener receiving aperture 121 can be a threaded aperture to receive fastener 88.

Referring to FIG. 12, bracket 93 details shown are similar to bracket 91, with bracket 91 created in a mirror image of bracket 93, therefore only bracket 93 will be further discussed. Bracket 93 includes engagement section 130 positioned between first and second element side walls 136, 138. First and second element side walls, together with a third side wall include first, second, and third radial portions 150, 152, and 154 which substantially match a diameter of second housing portion 62. Third element side wall 148 is displaced from second element side wall 136 by a bracket flange portion 156. First element side wall 138 is fixedly connected to an end flange 157 by a weld joint 158. Similarly, third element side wall 148 is fixedly connected to end flange 157 by a weld joint 160. An aperture 162 having a weld nut 164 coaxially aligned with aperture 162 normally receives fastener 88 of shock absorber 68, however when second height adjustment block 54 is installed, fastener 88 is removed from aperture 162 and fastener 146 is threadably engaged with weld nut 164 to capture second end wall 110. A pin engagement aperture 166 can receive pin 106 of second leaf spring 50, however pin engagement aperture 166 is not used when second height adjustment block 54 is used, because pin receiving aperture 107 of second height adjustment block 54 receives pin 106 in this condition. A fixture pin locating aperture 168 can also be used, which engages a pin (not shown) of a fixture assembly used during assembly of golf car 10.

Use of height adjustment blocks of the present disclosure for leaf spring suspension support of golf cars and similar vehicles offers several advantages. Height adjustment block installation is simplified requiring only a single fastener based on the configuration of engagement member 118 and the rotatable installation of the height adjustment blocks. A desired vertical height change for the axle housing can be obtained by increasing or decreasing the lift dimension “N” as desired. Use of the free extending portion 127 having first fastener receiving aperture 120 provides a predetermined co-axial alignment of apertures for installation of a fastener 146 to join the height adjustment block to the corresponding support element. The relative engagement of the leaf springs to the axle housing is maintained through use of the pin receiving aperture of the height adjustment blocks which receives the pin provided with the leaf spring. Installation of height adjustment blocks of the present disclosure therefore does not require modification of the pin or pin location of the leaf spring.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A suspension system height adjustment device for a golf car, comprising:
a substantially planar main segment;
a side wall connected to the main segment and homogenously joined to a connecting wall, the side wall and the connecting wall substantially defining an L-shape with the side wall oriented substantially transverse to the main segment;
opposed first and second end walls each transversely positioned with respect to the side wall and homogenously connected to the main segment; and
a hook-shaped engagement member extending from the first end wall and directed toward the second end wall.

2. The adjustment device of claim 1, further comprising
a first support surface defined by the connecting wall; and
a second support surface defined by the main segment, the second support surface oppositely facing with respect to the first support surface, the main segment and the connecting wall defining a cavity therebetween.

3. The adjustment device of claim 2, further comprising a second end wall length greater than a first end wall length, defining a free extending portion of the second end wall, extending beyond the first support surface.

4. The adjustment device of claim 1, wherein the side wall defines a homogenous extension of the main segment.

5. The adjustment device of claim 1, further comprising a first weld joint fixedly connecting the first end wall to the side wall and a second weld joint fixedly connecting the second end wall to the side wall.

6. The adjustment device of claim 1, further comprising first and second fastener receiving apertures created in the second end wall, and coaxially aligned with respect to an edge of the second end wall.

7. A height adjustable suspension system for a golf car, comprising:
an axle housing;
a support element fixedly connected to the axle housing; and
a height adjustment block connected to the support element, the height adjustment block including:
a substantially planar main segment;
oppositely positioned first and second end walls transversely oriented with respect to and homogenously extending from the main segment; and
a hook-shaped engagement member extending from the first end wall directed toward the second end wall;
wherein the hook-shaped engagement member is operable to engage the support element.

8. The suspension system of claim 7, further comprising:
a side wall homogenously extending from the main segment; and
a connecting wall homogenously joined to the side wall;
wherein the side wall and the connecting wall substantially define an L-shape with the side wall oriented substantially transverse to the main segment and perpendicular to both the first and second end walls.

9. The suspension system of claim 8, further comprising:
a plurality of weld joints each fixedly connecting one of the first and second end walls to the side wall;
wherein the side wall, both the first and second end walls and the main segment together define a cavity therebetween.

10. The suspension system of claim 7, further comprising a leaf spring positioned in contact with a support surface of the main segment, wherein the height adjustment block is positioned between the leaf spring and the support element.

11. The suspension system of claim 10, further comprising:
a support plate oppositely positioned about the leaf spring from the height adjustment block;
a U-shaped bolt operable to couple the axle housing, the height adjustment block and the leaf spring; and
a plurality of fastening nuts fastenably connected to the U-shaped bolt to engage the support plate to the leaf spring.

12. The suspension system of claim 10, further comprising a pin extending from the leaf spring received in an aperture created in the main segment.

13. The suspension system of claim 7, further comprising
an extending portion of the second end wall; and
a fastener inserted through an aperture created in the extending portion operable to engage the second end wall to the support element.

14. A height adjustable suspension system for a golf car, comprising:
a leaf spring;
an axle housing rotatably supporting first and second driven wheels, the axle housing connected to the leaf spring;
a support element fixedly connected to the axle housing; and
a height adjustment block connected to the support element, the height adjustment block including a hook-shaped engagement member at least partially engaging the height adjustment block to the support element;
wherein the height adjustment block is positioned between the leaf spring and the support element and is operable with the support element to define a spacing between the leaf spring and the axle housing.

15. The suspension system of claim 14, wherein the height adjustment block further comprises a substantially planar main segment defining a first support surface positioned in contact with the leaf spring.

16. The suspension system of claim 15, wherein the height adjustment block further comprises:
opposed first and second end walls each transversely positioned with respect to and homogenously extending from the main segment;
wherein the engagement member extends from the first end wall.

17. The suspension system of claim 16, wherein the height adjustment block further comprises:
a side wall homogenously extending from the main segment;
a connecting wall homogenously extending from the side wall, the side wall and the connecting wall defining an L-shape; and
a second support surface defined by the connecting wall oriented substantially parallel to the first support surface, the second support surface positioned in contact with the support element.

18. The suspension system of claim 17, further comprising:
an extending portion of the second end wall extending beyond the second support surface; and
a fastener inserted through an aperture created in the extending portion operable to engage the second end wall to the support element.

19. The suspension system of claim 18, further comprising a shock absorber fastenably connected to the second end wall.

20. The suspension system of claim 17, further comprising a plurality of weld joints each fixedly connecting both the side wall and the connecting wall to one of the first and second end walls.

21. A height adjustable suspension system for a golf car, comprising:
an axle housing rotatably supporting first and second driven wheels;
a support element fixedly connected to the axle housing;
a height adjustment block connected to the support element, the height adjustment block including:
a substantially planar main segment defining a first support surface;
opposed first and second end walls each transversely positioned with respect to and homogenously extending from the main segment;
a side wall homogenously extending from the main segment and homogenously joined to a connecting wall, the connecting wall defining a second support surface oriented substantially parallel to the first support surface; and
a hook-shaped engagement member extending from the first end wall and directed toward the second end wall operable to engage the support element; and
a leaf spring positioned in contact with the first support surface, wherein the height adjustment block is positioned between the leaf spring and the support element.

22. The suspension system of claim 21, further comprising an engagement section of the support element operable to engage the hook-shaped engagement member.

23. The suspension system of claim 22, further comprising a width of the engagement member predetermined to be received between an opposed pair of support element side walls.

24. The suspension system of claim 21, further comprising:
a second support element connected to the axle housing; and
a second height adjustment block connected to the second support element.

25. The suspension system of claim 21, further comprising a shock absorber having a connecting sleeve fastenably connected to the height adjustment block.

26. The suspension system of claim 21, further comprising a fastener disposed through a fastener receiving aperture created in the second end wall to engage the height adjustment block when the hook-shaped engagement member is engaged with the support element.

27. A golf car, comprising:
a frame member;
a leaf spring supported from the frame member;
an axle housing rotatably supported between the leaf spring and the frame member;
a support element fixedly connected to the axle housing; and
a height adjustment block connected to the support element, the height adjustment block including a hook-shaped engagement member at least partially engaging the height adjustment block to the support element;
wherein the height adjustment block is positioned between the leaf spring and the support element and operable with the support element to define a spacing between the leaf spring and the axle housing.

28. The golf car of claim 27, further comprising:
an axle rotatably disposed in the axle housing; and
first and second driven wheels connected to the axle.

29. The golf car of claim 28, further comprising a diameter of the driven wheels being predetermined by a lift dimension of the height adjustment block.

30. The golf car of claim 27, further comprising a shock absorber connected by a first connecting sleeve to the frame member and by a second connecting sleeve to the height adjustment block.

31. The golf car of claim 27, further comprising:
a pin extending from the leaf spring; and
a pin receiving aperture created in the height adjustment block operable to receive the pin.

32. A method for adjusting a height of a golf car suspension system, the suspension including an axle housing, a support element connected to the axle housing, a height adjustment block, and a leaf spring, the method comprising:
separating the leaf spring from the support element;
connecting an engagement member of the height adjustment block with the support element;
rotating the height adjustment block to abut the support element;
fastening the height adjustment block to the support element; and
coupling the leaf spring to both the height adjustment block and the axle housing.

33. The method of claim 32, further comprising disconnecting a shock absorber from the support element prior to the separating step.

34. The method of claim 33, further comprising fastening the shock absorber to the height adjustment block.

35. The method of claim 32, further comprising increasing a diameter of a pair of driven wheels rotatably connected to the axle housing.

36. The method of claim 32, further comprising positioning a support plate in contact with the leaf spring opposite to the height adjustment block prior to the coupling step.
